(19) United States
(12) Patent Application Publication
(10) Pub. No.: US 2003/0150288 A1
(43) Pub. Date: Aug. 14, 2003

(54) Device for multi-axis fine adjustable bearing of a component

(76) Inventors: Tino Noll, Berlin (DE); Wolfgang Gudat, Berlin (DE); Heiner Lammert, Mahlow (DE)

Correspondence Address: Law Offices of Kark Hormann, PO Box 381516, Cambridge, MA, 02238-1516, US

(21) Appl. No.: 10/362,321

(22) PCT Filed: Aug. 16, 2001
(86) PCT No.: PCT/DE01/03097

(30) Foreign Application Priority Data
Aug. 20, 2000 (DE) 100 421 802.9

(51) Int. Cl. B25J 17/00

(52) U.S. Cl. 74/490.07

(57) ABSTRACT

Known component suspensions either use six parallel double-jointed members (hexapods) that while being adjustable with six degrees of freedom and high accuracy can only be adjusted in mutual dependency of one another, or double-jointed members that are mounted in series via connecting bodies and whose joints can be rotated about one axis, that allow only two rotational deflections, under error summation, and that meet in a virtual point as the point of origin of a Cartesian coordinate system. The aim of the invention is to design a suspension that allows a movement of the component in all six degrees of freedom in a highly accurate, reproducible manner while maintaining the axial rigidity of the component. To this end, six parallel double-jointed members (2J₁, 2J₂, 2J₃, 2J₄, 2J₅ 2J₆) comprising two joints (J₁, J₂) each that can be rotated about three axes are distributed in the coordinate planes (XY<XZ, ZY) in such a manner that the rotational (xᵣₒₜ, yᵣₒₜ, zᵣₒₜ) and translational (xₜᵣₐₙₛ, yₜᵣₐₙₛ, zₜᵣₐₙₛ) deflections can be achieved by adjusting, if possible, only one double-jointed member (2J₁, 2J₂, 2J₃, 2J₄, 2J₅ 2J₆) (defined adjustment). The joints (J₁, J₂) preferably used in the double-jointed members (2J₁, 2J₂, 2J₃, 2J₄, 2J₅ 2J₆) are flexible joints (J₁, J₂), especially elastic fiber joints. The inventive joints can be used in suspensions of optical components, especially mirrors.)

### DESCRIPTION

The invention relates to an apparatus for the multi-axial precision adjustable suspension of a component for small deflections by the multi-membered connection thereof with a multi-jointed frame with at least four double-jointed members of high axial stiffness the center axis of which extends through two joints which are spaced from each other and which are at least uni-axially rotatable and which are arranged for static interaction such that

a) three double-jointed members (2J₁, 2J₂, 2J₃) have a virtual common intersection (P);

b) the intersection (p) is the origin of a Cartesian coordinate system (x, y, z);

c) two (2J₁, 2J₂) of the double-jointed members (2J₁, 2J₂, 2J₃) of pont a) with their center axes (MA) lie in a first plane (YZ) of the coordinate system (x, y, z);

d) the third (2J₂) one of the three double-jointed members (2J₁, 2J₂, 2J₃) of point a) with its center axis lies in a second plane (XY) of the Cartesian coordinate system vertical of the first plane (YZ).

A frame with a suspension of this kind is known from EP 0,665,389 and may be used to bear optical components such as, for instance, lenses or, primarily, mirrors, with a precision adjustability of the deflections of the frame up to 2° at a setting precision of 1°. The component to be supported by the known frame may be rotated about two axes at a maximum. For the rotation about each axis the apparatus is provided with two obliquely disposed double-jointed members the imaginary extension of which constitutes the center of revolution as a virtual intersection. In the known suspension this intersection is positioned in the upper surface of the component to be supported. The two double-jointed members are positioned in a first plane upon which the rotational axis is vertically disposed. Even though the description refers to the possibility of a suspension by a total three double-jointed members, it prefers, nevertheless, a suspension by four double-jointed members since it may be controlled more easily and with greater accuracy. The two second double-jointed members (or the third double-jointed member) are also aligned with respect to the intersection and are positioned in a second plane disposed vertically of the first plane. Accordingly, the second rotational axis is either fixed in a statically defined system or it is a Cartesian coordinate system the origin of which is positioned in the center of revolution. However, in the known suspension the third axis thereof is ignored since at a maximum a suspension rotatable about two axes only is to be realized.

The joints disclosed by EP 0,665,389 which in pairs form a double-jointed member and which are arranged at the opposite ends thereof, are formed uni-axially so that it is not possible to attain the requisite axial stiffness for high adjustment accuracy. Accordingly, the double-jointed members disposed in one plane admit of one uni-axial deflection only. In order to realize a dual-axially rotatable suspension, in the known apparatus the first two double-jointed members are disposed for a first direction of rotation and the second two double-jointed members are disposed for a second direction of rotation, in a static serial interaction. The sequential actuation of the corresponding double-jointed members is achieved by a connection member of relative structural complexity as a further structural component in the known frame which must be automatically energized by a spherically controlled linear motor. This is to yield sweep dynamics in the range of 400 Hz. However, serial connections of double-jointed members are to be considered as disadvantageous as they lead to an addition of the adjustment errors occurring in every double-jointed member and to a reduction of the axial stiffness of the frame necessary for a high adjustment accuracy. For this reason the known apparatus provides for a further double-jointed member which is disposed in the direction of the longitudinal axis of the apparatus and which only serves to provide axial stiffness.

Serial connections of individual joint members are also known from various other publications relating to the prior art. Usually, these are guides in series-connected stack arrangements. For instance, FR 2,761,486 discloses an apparatus for precision adjusting in the μm range at a maximum of six degrees of freedom and which is provided with three turrets each with three adjustable calipers. With the three turrets there is connected a support for the component to be suspended which may be precision adjusted along six axes relative to a frame. Moreover, apparatus are known which provide for a gimbal-like system by a suitable arrangement of ball bearings and which realize the suspension by a combination of lifting tables and angulometers with spherical trajectories.

The so-called hexapod is known from FR 2,757,440 as the classic embodiment of a device for a six axis axially stiff suspension with static parallel interaction between individual double joints. This is a six-legged adjustment device with six longitudinally adjustable legs which are arranged in a circle in a zig-zag pattern. The legs are structured as double-jointed members with a ball bearing at each end. However, ball bearings are subject to a number of disadvantages which cannot always be tolerated such as, for instance, stochastic movement errors as a result of form tolerances inherent in the manufacture of the rolling ball surfaces and races which prevent a highly precise reproducibility of the adjustments. Where the irregularity is compensated by lubricants or coatings settings, such ball bearings can only be utilized to a limited extent. In particular, they cannot then be used at all under conditions involving a vacuum. The greater disadvantage of the use of a hexapod is, however, to be seen in the complicated interaction between the individual double-jointed members for attaining multi-axial adjustments. Even single-axis adjustments as a rule require movement or longitudinal adjustment of all double-jointed members, with the relevant interdependencies not being recognizable without some difficulties. Manual adjustments are only possible with difficulty and only with the aid of tables previously composed with considerable effort. While computer-assisted automatic controls may offer a solution, they require complex and time-consuming computer programs. Furthermore, the particularly expensive automatic control requires electrically powered servomotors to provide for longitudinal adjustments, the heat emission of which may have a detrimental effect on the overall system and would thus be undesirable.

Based upon the first-mentioned publication EP 0,665,389 which discloses the most relevant state of the art, it is an object of the invention so to improve an apparatus for a precision adjustable multi-axial suspension of a component of the kind referred to above that the component to be suspended may be moved in a maximum of six degrees of freedom about the origin of the Cartesian coordinate system. In this connection, any deflections are to be realized without significant efforts in terms of mathematical programs and controlled drives and, as much as possible, independently of each other. The number of requisite adjustment movements is to be kept at a minimum. The axial stiffness of the suspension is to be retained. A mechanical suspension is to be realized which is particularly sensitive and highly accurate in terms of adjustability and which is immune from oscillations.

In the accomplishment of this object the invention provides for a frame which for a three-axes suspension of the component adjustable in a maximum of six possible Cartesian axes is structured as six double-jointed members provided with six three-axial joints with six double-jointed members and for all double-jointed members being arranged in a static parallel interaction relative to each other, whereby

e) the fourth double-jointed member with its center axis also lies in the second plane,

f) a fifth double-jointed member is provided which with its center axis also lies in the first plane, and

g) a sixth double-jointed member is provided which with its center axis lies in the third plane formed by the Cartesian coordinate system.

In its basic general structure the apparatus in accordance with the invention is characterized by an arrangement of six double-jointed members for generating a three-axis deflection in a Cartesian coordinate system, i.e. in a maximum of six Cartesian axes (three rotational, three translational). The basic assumption for the realization is that for small rotations of a leg-based system the rotational axes are defined by the theoretical intersection of the legs. This renders the function of the apparatus in accordance with the invention very simple; the individual deflections which affect each other insignificantly only may be achieved by manual adjustment of one but no more than three double-jointed members. Certain directions of deflection may be correspondingly preferred. The suspension of the apparatus of the invention is statically unambiguously defined and is axially particularly stable and immune from oscillations. In this manner, precision adjustments may be achieved to the highest degree. The static parallel interaction between the six double-jointed members also contributes to a further improvement of these accuracies. By arranging them in parallel occurring errors of the stochastic or systemic kind are not added thus rendering the total error insignificant. Predetermined adjustments may be reproduced without play and with highest precision.

The first, second and third double-jointed members form a first group of double-jointed members which define the origin of a Cartesian coordinate system and the direction of the three Cartesian planes. Two planes are defined by the position of the double-jointed members; the third plane results automatically from the orthogonality condition at the origin, so that in this plane there is no double-jointed member from the first group. The fourth, fifth and sixth double-jointed members form a second group of double-jointed members which each are disposed in one of the three planes. There arrangement is relevant for the deflections to be attained. If the double-jointed members are disposed in the planes at an arbitrary but technically reasonable orientation combined deflections will result which possibly may not be required at all.

For that reason it is, in accordance with embodiments of the invention, particularly efficacious and advantageous if for producing rotational deflections at least one double-jointed member from the fourth, fifth and sixth double-jointed members forming the second group is arranged at a defined distance to the origin of the Cartesian coordinate system and if for producing translational deflections at least one double-jointed member from the second group formed by the fourth, fifth and sixth double-jointed members is arranged parallel to one of the double-jointed members of the first, second and third double-jointed members forming the first group. For rotational deflections, a lever arm is thus produced which is directly used manually or which may serve to mount a drive. In its translational movability the arrangement of the further double-jointed members generates parallelograms which make possible parallel shifting of the corresponding edges of the members. A further discussion of the further interaction of double-pointed members arranged in this manner is dispensed with. For the sake of avoiding repetitions reference should be had to the embodiments in the specific section of the specification.

The invention is directed to the most variegated applications. A frequent application will be the suspension of a scanning mirror for the precise reflection impinging upon its surface so that even at a distance of 20 m to 30 m an adjustment precise to the point will be possible with the highest precision. Particularly in applications involving optical components interacting with light beams it is important to avoid their being impeded by other structural components, especially the suspension of such components. For that reason, a further embodiment of the invention provides for slight displacement of the double-jointed members from the three planes of the Cartesian coordinate system. This does not lead to a change in the interaction of the suspension of the apparatus in accordance with the invention. The user is in a position, however, to a certain extent to modify the arrangement of the individual double-jointed members. This is to be expressed by the tern “slight” as a statement in terms of mm does not seem to make sense because of the dependency from other structural parameters. It is important that the given double-jointed member not be moved out of its corresponding plane any further than to prevent shading of the light beam. This will also result in a simplification of the assembly of the individual double-jointed members. Measures known from the state of the art such as the creation of free access from beneath the structure or structural recesses in “interfering” components are not required in connection with the invention.

A further modification of the arrangement of individual double-jointed members in accordance with the invention is possible if in accordance with a further embodiment the arrangement of the six double-jointed members in the six-jointed frame additionally conforms to the dimensions of the component to be suspended. This, too, does not result in a change of the interaction of the arrangement. Since in the distribution scheme of the individual double-jointed members the creation of a plane is possible in which there is arranged only one double-jointed member, it is possible with flat rectangular components (mirrors) to move this plane to the narrow front surface of the component. Problems of suspending the double-jointed members are thus avoided. In this connection, it is assumed that in accordance with a further embodiment of the invention the component axes are aligned coaxially relative to the Cartesian axes. Such an association, which includes the parallel association, in the individual planes and axes of the Cartesian coordinate system provides for greater clarity when associating the elements and the deflections to be achieved. However, it is not always required or possible. For instance, parallelepipeds may be suspended by a point or balls.

The double-jointed members known from the state of the art most closely related to the invention are structurally unchangeable and are constructed uni-axially. That is to say, they may be tilted along one axis only in order to ensure the demanded high axial stiffness. The tilting angles are achieved by shifting the all of the double-jointed members by means of a central drive which is moved on a spherical shell. For this application, the high dynamic of the tilting movement of up to 400 changes per second is of primary importance. However, in applications designed to provide for few shifts in order to interfere as little with the entire structure as possible, it may be advantageous to construct, in accordance with a further embodiment of the invention, the double-jointed members longitudinally changeable along their center axis. This may be accomplished by a spindle structure of advantageously high stiffness. Such a structure makes it possible that, in accordance with a further embodiment of the invention, for every deflection relative to one of the six Cartesian axes there is provided a separate device for changing the length of shifting the joints of double-jointed members. These may be the mentioned spindles. The individual double-jointed members may, however, also be mounted for shifting within the frame, as, for instance, by calipers.

The three-axially rotatable arrangement of the joints makes possible the simple possibilities of deflection of the apparatus in accordance with the invention in a parallel arrangement of all double-jointed members in the suspension. Care is to be taken, however, that the joints satisfy the demands placed on them. The use of ball bearings as classic three-axial joints entails the disadvantages referred to above, in particular the high stochastic topographic error as a result of irregular rolling surfaces and the frequent unsuitability for operation in vacuum. The same is true of cardanic arrangements of rotational ball and slide bearings as well as spherical inserts suspended in encasing housings. For that reason the three-axial joints may, in accordance with a further embodiment of the invention, be structured as flexible joints. Flexible joints are known per se and satisfy the demands placed on them. Such joints include leaf spring joints including crossed ones, resilient universal joints and solid joints. They are monolithic arrangements with material constrictions.

Advantageously and in accordance with a further embodiment of the invention, the flexible joint is structured as an elastic fiber joint with two rigid joint ends structured as sockets and a short piece of fiber material as intermediate deformation section. In accordance with a further embodiment of the invention the fiber material may be a steel cable. Such a fiber joint is of simple structure and easy to manufacture. Suitable semifinished products avoid structural requirements which can only be attained by material processing (constrictions). It combines the advantages of flexible joints (no play, reproducibility, suitability for vacuum) and the three-dimensional movability of classical ball bearings. Relative to monolithic flexible components their axial stiffness is very high. The possible flex angles are defined by the ratio between the exposed length of the fiber material between the joint ends and its diameter. The diameter of the fiber material determines the permissible load as well as the axial tensile and compression stiffness. Because of the fibrous structure of the deformation section the fiber joint does not rupture suddenly in case of an overload, but, rather, wear becomes apparent as gradual fraying of the fibers. Hence, the fiber joint may always be replaced in time before any damage occurs. While at a high overload the fiber joint may kink are squeeze, it keeps the joint ends together so that the connection as such is maintained. This, too, contributes to preventing great damage. Axial stiffness is further improved by a fiber material composed of a plurality of thin individual fibers which are twilled or braided. In particular, the fiber material may be a steel cable. Such steel cables are inexpensive and prefabricated and are available in a large number of different structures, (e.g. Bowden cables) dimensions and materials. Furthermore, in such elastic fiber joints the fiber material may be rigidly connected to the joint ends by clamping, peening or adhesion. Such simple connection techniques contribute to the simple fabrication of a fiber joint and ensure its safe operation.

Embodiments of the invention will hereafter be described in greater detail with reference to schematic drawings in which:

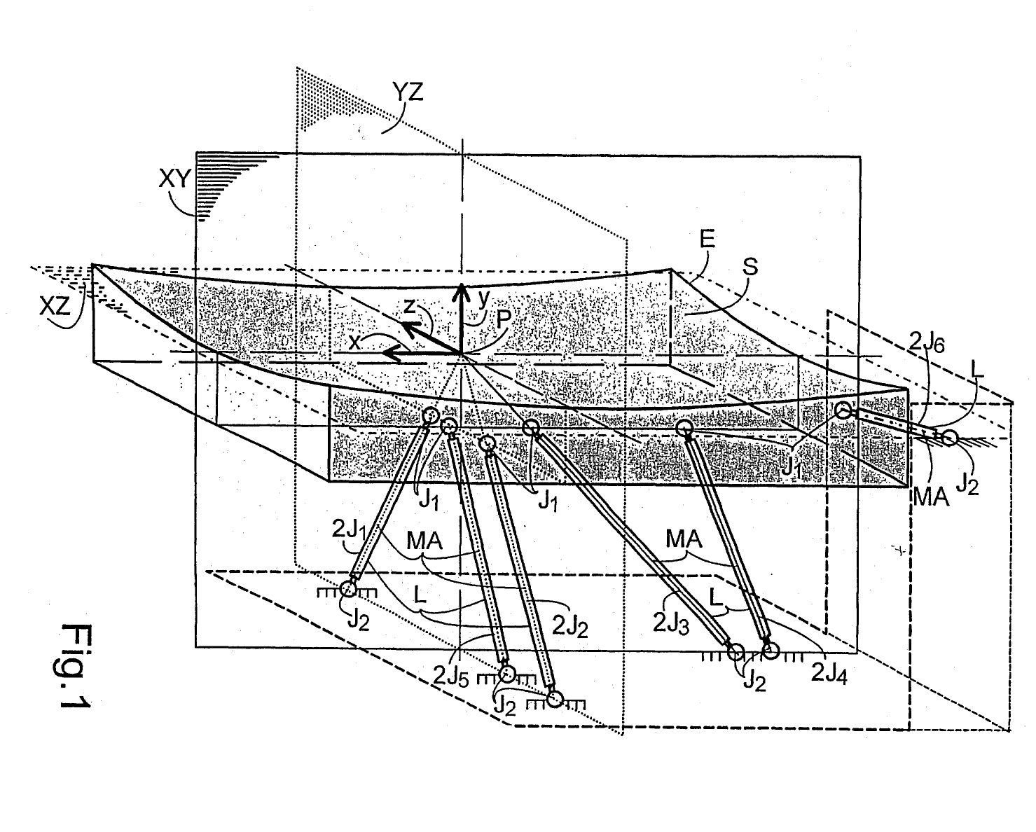

FIG. 1 is a basic diagram of the arrangement of the six double-jointed members as a detail of the apparatus in accordance with the invention;

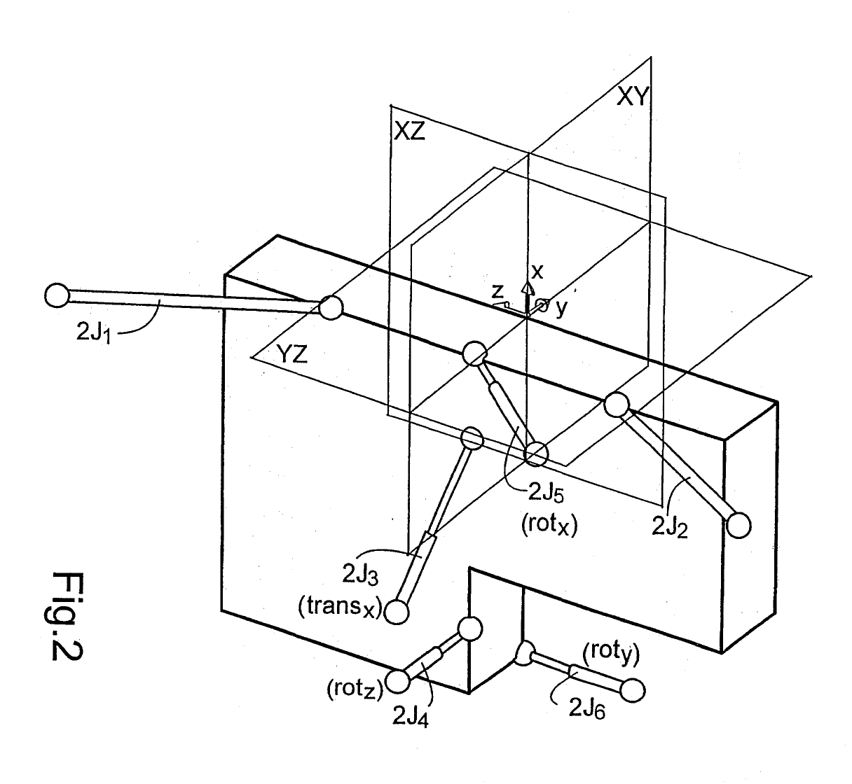

FIG. 2 is a diagram of the arrangement of FIG. 1 in a simplified spatial representation;

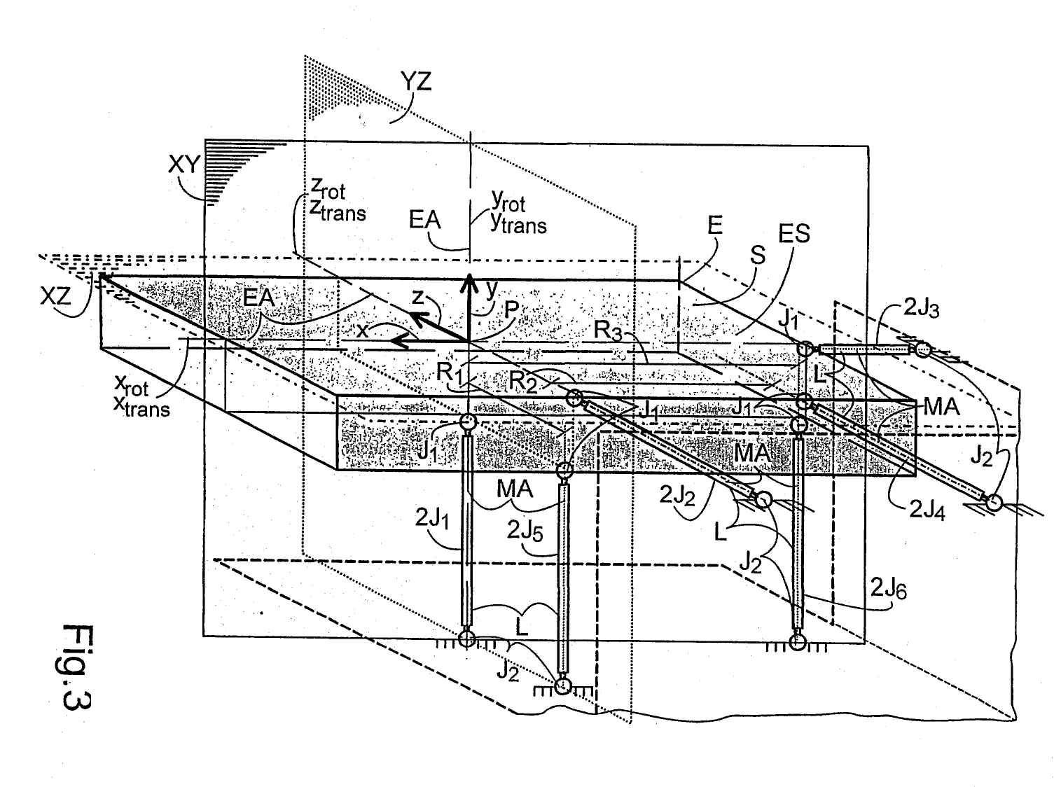

FIG. 3 is an orthogonal arrangement of the six double-jointed members as an embodiment of the apparatus in accordance with the invention;

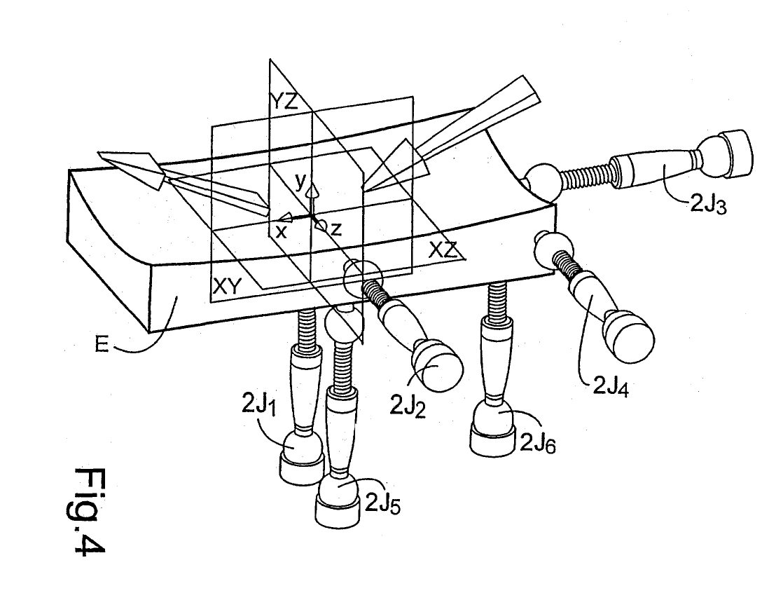

FIG. 4 is the arrangement of FIG. 3 in a simplified spatial representation; and

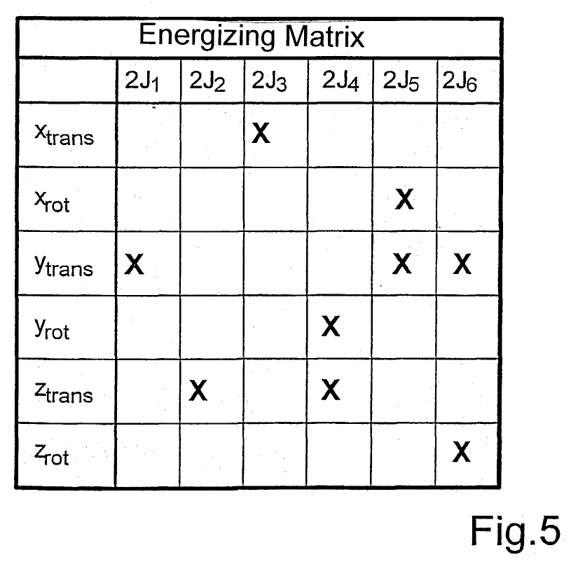

FIG. 5 is an energization matrix for the arrangement of FIGS. 3 and 4.

FIG. 1 depicts, as a structural component E, a mirror the upper surface S of which is shaped concavely. The component E is structured as a six-pointed member. This relation is generated by the component E being suspended in a six-jointed frame by six double-jointed members 2J₁, 2J₂, 2J₃, 2J₄, 2J₅ and 2J₆. For reasons of clarity, FIG. 1 only depicts the junction of the six double-jointed members 2J₁, 2J₂. 2J₃, 2J₄, 2J₅ and 2J₆ with the component E (gray background) for its suspension. The second suspension in the six-jointed frame is accomplished at each of the opposite ends of the double-jointed members 2J₁, 2J₂. 2J₃, 2J₄, 2J₅ and 2J₆. An appropriately shaped frame (depicted in the Figure by dash-dotted lines) may be of any possible structure and corresponds to the common technological knowledge relating to such frames. All six of the double-jointed members 2J₁, 2J₂. 2J₃, 2J₄, 2J₅ and 2J₆. Are arranged statically parallel relative to each other between the frame and the suspended component E.

This general arrangement is also depicted in FIG. 2 in another constellation for suspending a component E provided with an extension. For greater clarity, most of the auxiliary lines and planes as well as reference characters relating to details of FIG. 1 were eliminated. Only the six double-jointed members 2J₁, 2J₂. 2J₃, 2J₄, 2J₅ and 2J₆. And the coordinate system x, y, z in the intersection P are shown. It may, however, be seen in FIG. 2 that two double-jointed members 2J₁, 2J₂ which contribute to forming the intersection P, are not structured for changing their position. They serve to arrest the component; no translational movement of the component in the direction of the y and z axes can take place. The possible movements are shown.

The double-jointed members 2J₁, 2J₂. 2J₃, 2J₄, 2J₅ and 2J₆. Are each provided with two joints J₁ and J₂ at their opposite ends, with a center axis MA extending therethrough. They are structured axially stiff, i.e. along their center axes and, in the embodiment selected, their length L may be adjusted. The joints J₁, J₂ are structured three-axially; in the selected embodiment ball joints are depicted symbolically. In real embodiments flexible joints, more particularly elastic fiber joints, are to be preferred.

The three double-jointed members 2J₁, 2J₂ and 2J₃ form a first group and are arranged such that they have a common virtual intersection P in the surface S of the suspended component E. This intersection P coincides with the origin of a Cartesian coordinate system with axes x, y and z and correspondingly disposed orthogonal planes XY, XZ and YZ. The designations of the axes of the coordinate system may, however, be interchanged; in the selected embodiment the orientation is along the edges of the body of the component E. The two double-jointed members 2J₁ and 2J₂ and their center axes MA are disposed in a first plane YZ of the coordinate system. The third double-jointed member 2J₃ with its center axis MA is disposed in the second plane XY of the coordinate system, the alignment of which is defined in all three planes, including the third plane XZ.

A second group is formed by the three double-jointed members 2J₄, 2J₅ and 2J₆, of which the fourth double-jointed member 2J₄ with its center axis MA is also disposed in the second plane XY. At the same time, the fifth double-jointed member 2J₅ with its center axis MA is also disposed in the first plane YZ. Hence, the first plane YZ is occupied by a total of three double-jointed members 2J₁, 2J₂ and 2J₅, and the second plane XY is occupied by two double-jointed members 2J₃ and 2J₄. Finally, the sixth double-jointed member 2J₆ with its center axis MA is disposed in the third plane XZ, this plane being thus occupied by one double-jointed member only. Depending upon the number of occupying double-jointed members, the planes, as engagement surfaces of the supports, may thus be of different sizes and may be adjusted to the geometric surfaces S of the suspended component E. A small dimension of the component may thus preferably be disposed in the direction of the y axis relative to which only the sixth double-jointed member 2J₆ is vertically aligned.

A similar arrangement is depicted in FIG. 3. This concerns the case of all double-jointed members 2J₁, 2J₂, 2J₃, 2J₄, 2J₅ and 2J₆ being disposed orthogonally with respect to each other. In this case, the component E is shaped like a flat parallelepiped; in an actual case this may, for instance, be a scanning mirror with a concave surface S. In the embodiment, the scanning mirror E is suspended such that its dimension ES is disposed in the direction of the y axis. The component axes EA are thus coaxially disposed relative to the Cartesian axes x, y, z. For generating rotational deflections—in the embodiment shown, rotations are possible about all three axes xᵣₒₜ, yᵣₒₜ, zᵣₒₜ—all three double-jointed members 2J₄, 2J₅ and 2J₆ of the second group are arranged at a defined distance R₁, R₂ and R₃ (lever arm) from the origin P of the Cartesian coordinate system. The distance may be defined as the radius R of rotation and may be freely selected with reference to the static mechanics. The double-jointed members 2J₄, 2J₅ and 2J₆ will then be tangentially positioned at the relevant circle of rotation. These circles in the three Cartesian planes of the component E yield rotating theoretical lines along which the corresponding double-jointed member may be arbitrarily positioned in order to generate a rotation (clockwise or counter clockwise) about the corresponding axis of rotation disposed vertically on the plane of the circle of rotation (see FIG. 1).

Furthermore, in the embodiment shown in FIG. 3, translational deflections are possible along all three axes xₜᵣₐₙₛ, yₜᵣₐₙₛ, zₜᵣₐₙₛ. All of the three double-jointed members 2J₄, 2J₅ and 2J₆ of the second group are additionally arranged parallel or vertically of the translations along axes xₜᵣₐₙₛ, yₜᵣₐₙₛ, zₜᵣₐₙₛ . In this manner, parallelograms are generated which affect a parallel shift or translation of the sides of the component along the Cartesian axes xₜᵣₐₙₛ, yₜᵣₐₙₛ, zₜᵣₐₙₛ.

FIG. 4 depicts a simplified perspective view of the double-jointed constellation of FIG. 3 for suspending a component E. In the embodiment here shown, the component E is a concave scanning mirror which reflects an impinging light ray with extreme precision. For greater clarity, most of the auxiliary lines and planes as well as reference characters for details of FIG. 3 have been eliminated. Six double joints 2J₁, 2J₂, 2J₃, 2J₄, 2J₅ and 2J₆ are shown which serve to effect a change in position of the component E along all six Cartesian axes xₜᵣₐₙₛ, yₜᵣₐₙₛ, zₜᵣₐₙₛ, xᵣₒₜ, yᵣₒₜ, zᵣₒₜ. The schematically shown ball joints serve to demonstrate the three-axially rotatable movability. Also, the depicted changes in length are only to indicate the shiftability of the points of engagement at the component E.

FIG. 5 depicts a table. The depicted energizing matrix shows which double-jointed members have to be energized in order to generate deflections with each of the maximally six possible degrees of freedom. It may be clearly seen that rotations may be generated about all three rotational axes xᵣₒₜ, yᵣₒₜ, zᵣₒₜ, each by adjusting or shifting of but a single double-jointed member 2J₄, 2J₅ and 2J₆. The translation in the x direction is generated solely by movement of the double-jointed 2J₃. Hence, these deflections are extremely simple and may be reproduced with extreme precision by manual or automatic actuation of only drive. In this connection, it is significant that rotations exert a much greater influence on the positioning of the component than do the translations, particularly in case of a mirror. The translation in the z direction requires adjustment of two double-jointed members 2J₂, 2J₄ by the same amount. This may still be called simple adjustability. At a maximum, three double-jointed members 2J₁, 2J₅, 2J₆ will have to be adjusted by the same amount in order to bring about a translation in the y direction.

### List of Reference Characters

| | |
|---|---|
| E | component |
| EA | component axis |
| ES | small component dimension of E |
| S | surface of E |
| Jₘ | joint (m = 1, 2) |
| 2Jₙ | double-jointed member (n = 1, 2, 3, 4, 5, 6) |
| L | longitudinal adjustment of Jₘ |
| MA | center axis of Jₘ |
| P | common virtual intersection (origin) |
| R | radius of rotation |
| R₁, R₂, R₃ | defined distance from the origin P (lever arm) |
| x, y, z | axes of the Cartesian coordinate system |
| xᵣₒₜ, yᵣₒₜ, zᵣₒₜ | axes as rotational axes |
| xₜᵣₐₙₛ, yₜᵣₐₙₛ, zₜᵣₐₙₛ | axes as translational axes |
| XY, XZ, YZ | planes of the Cartesian coordinate system |

1. Apparatus for a multi-axial precision adjustable suspension of a component for small deflections by the multi-membered connection thereof with a multi-jointed frame of at least four double-jointed members of high axial stiffness the central axis of which extends through two joints spaced from each other and rotatable about at least one axis and which are arranged in a static interaction such that
a) three double-jointed members (2J₁, 2J₂, 2J₃) share a virtual common intersection (P);
b) this intersection (P) is the origin of a Cartesian coordinate system (P);
c) two (2J₁, 2J₂) of the three double-jointed members (2J₁, 2J₂, 2J₃) of point a) with their center axes (MA) lie in a first plane (YZ) of the coordinate system (x, Y, z);
d) the third (2J₃) one of the three double jointed members (2J₁, 2J₂. 2J₃) of point a) with its center axis (MA) lies in a second plane (XY) of the Cartesian coordinate system disposed vertically of the first plane;
characterized by the fact that the frame is structured for a three-axial suspension of the component (E) which is precision adjustable in a maximum of six possible Cartesian axes (xᵣₒₜ, yᵣₒₜ, zᵣₒₜ, xₜᵣₐₙₛ, yₜᵣₐₙₛ, zₜᵣₐₙₛ) of six double-jointed members (2J₁, 2J₂, 2J₃, 2J₄, 2J₅, 2J₆) of three-axially rotatable joints (J₁, J₂) and that all double-jointed members (2J₁, 2J₂, 2J₃, 2J₄, 2J₅, 2J₆) are arranged for a static interaction relative to each other, with
e) the fourth double-jointed member (2J₄) with its center axis (MA) also lying in the second plane (XY);
f) a fifth double-jointed member (2J₅) being provided which with its center axis (MA) also lies in the first plane (YZ); and
g) a sixth double-jointed member (2J₆) being provided which with its center axis (MA) lies in a third plane (XZ) set up by the Cartesian coordinate system (x, y, z).

2.) Apparatus of claim 1,
characterized by the fact that
for generating rotational deflections (xᵣₒₜ, yᵣₒₜ, zᵣₒₜ) at least one double-jointed member (2J₄, 2J₅, 2J₆) of the second group formed by the fourth, fifth and sixth double-jointed members (2J₄, 2J₅, 2J₆) is arranged at a defined distance (R₁, R₂, R₃) from the origin (P) of the Cartesian coordinate system (x, y, z).

3.) Apparatus of claim 1 or 2,
characterized by the fact that
for generating translational deflections (xₜᵣₐₙₛ, yₜᵣₐₙₛ, zₜᵣₐₙₛ) at least one double-jointed member (2J₄, 2J₅, 2J₆) of the second group formed by the fourth, fifth and sixth double-jointed members (2J₄, 2J₅, 2J₆) is arranged in parallel to a double-jointed member (2J₁, 2J₂, 2J₃) auf the first group formed by the first, second and third double-jointed members (2J₁, 2J₂, 2J₃).

4.) Apparatus of at least one of claims 1 to 3,
characterized by the fact that
the double-jointed members (2J₁, 2J₂, 2J₃, 2J₄, 2J₅ 2J₆) are arranged slightly displaced out of the three planes (XY, XZ, ZY) of the Cartesian coordinate system (x, y, z).

5.) Apparatus of at least one of claims 1 to 4,
characterized by the fact that
that the arrangement of the six double-jointed members (2J₁, 2J₂, 2J₃, 2J₄, 2J₅ 2J₆) in the six-jointed frame is additionally adjusted to the dimensions of the component (E) to be suspended.

6.) Apparatus of at least one of claims 1 to 5,
characterized by the fact that
the axes of the component (EA) are aligned coaxially of the Cartesian axes (x, y, z).

7.) Apparatus of at least one of claims 1 to 6,
characterized by the fact that
that the common virtual intersection (P) as origin of the Cartesian coordinate system (x, y, z) is positioned in the surface (S) of the component (E) to be suspended.

8.) Apparatus of at least one of claims 1 to 7,
characterized by the fact that
that the double-jointed members (2J₁, 2J₂, 2J₃, 2J₄, 2J₅ 2J₆) are structured for longitudinal (L) change along their center axis (MA).

9.) Apparatus of at least one of claims 1 to 8,
characterized by the fact that
for each deflection relative to one of the six Cartesian axes (xᵣₒₜ, yᵣₒₜ, zᵣₒₜ, xₜᵣₐₙₛ, yₜᵣₐₙₛ, zₜᵣₐₙₛ) there is provided a separate device for changing the length (L) or shifting of the joints (J1, J2) or double-jointed members (2J₁, 2J₂, 2J₃, 2J₄, 2J₅ 2J₆).

10.) Apparatus of at least one of claims 1 to 9,
characterized by the fact that
that the three-axially rotatable joints (J₁, J₂) are structured as flexible joints.

11.) Apparatus of claim 10,
characterized by the fact that
the flexible joint is structured as an elastic fiber joint with two rigid joint ends formed as sockets and a short piece of fiber material as a deformation section positioned therebetween.

12.) Apparatus of claim 11,
characterized by the fact that
the fiber material is structured as a steel cable.
